(19) United States
(12) Patent Application Publication
(10) Pub. No.: US 2022/0379221 A1
(43) Pub. Date: Dec. 1, 2022

(54) System for generating virtual golf course

(71) Applicant: Ivant Inc, Gyeonggi-do (KR)

(72) Inventors: Jin Hyuk YANG, Gyeonggi-do (KR); Changhwan SON, Gyeonggi-do (KR); Hyung Seok KIM, Gyeonggi-do (KR); Hosik KIM, Gyeonggi-do (KR); Wan Soo SHIN, Gyeonggi-do (KR); Il-gyu CHOI, Gyeonggi-do (KR); Won Jun PARK, Gyeonggi-do (KR); Yong Hui YU, Seoul (KR)

(21) Appl. No.: 17/382,370

(22) Filed: Jul. 22, 2021

(30) Foreign Application Priority Data
May 27, 2021 (KR) 10-2021-0068165

(51) Int. Cl. A63F 13/65; A63F 13/812; A63F 13/5378; G06T 17/20; G06T 17/05

(52) U.S. Cl. CPC A63F 13/65; A63F 13/812; A63F 13/5378; G06T 17/20; G06T 17/05; A63F 2300/307; A63F 2300/69; A63F 2300/8011

(57) ABSTRACT

A virtual golf course generation system of the present embodiment includes: a field template generation unit for generating a field template including information on a terrain and an altitude of a specific location and information on an object, by using a result classified or extracted from different map data so as to generate a virtual golf course; a 3D green terrain generation unit for generating a 3D green terrain by using a three-dimensional mesh generated using terrains and altitudes of a green and a green bunker of the actual golf course to be displayed on the virtual golf course; and a matching unit for matching the generated 3D green terrain with the field template to generate the virtual golf course.

### BACKGROUND OF THE INVENTION

### 1. Field of the Invention

The present invention relates to a system for generating a virtual golf course to which terrain information of a golf course green is applied, and a method for providing a putting practice using the same, and more particularly, to a system capable of generating a three-dimensional golf course through real-time matching a putting green of an actual golf course or an arbitrarily generated putting green to a virtual golf course other than the green.

In addition, the present invention relates to a system capable of generating various virtual golf courses including actual greens with a small data volume, and a method that enables a user to position for an effective putting practice by using the system, enables the user to effectively practice on a green selected by the user and provides useful hints during the putting.

### 2. Description of the Related Art

Recently, the popularity of screen golf courses is increasing. Anyone can easily enjoy golf simulation games as it is cheaper than using golf clubs, and screen golf courses enjoyable without restrictions of place and time are embodied within living zones of users.

As various screen golf companies are established, the expectations of the users who play screen golf games are increasing, and the users want to enjoy golf rounds in a more realistic environment.

Meanwhile, there are various factors that affect results of the game during golf in the actual golf course. For example, a golf shot ability of a player may exert an influence on the results, and the environment, such as the weather or terrain when the player plays the game, may also be a significant factor.

However, in the screen golf system proposed in the art, there is a limit to the number of golf courses that reflect states of terrains to provide virtual simulations. As a result, it is difficult to provide users with realistic and diverse golf courses.

### SUMMARY OF THE INVENTION

The present invention provides a virtual golf course generation system capable of serving as a putting simulator and capable of implementing actual putting greens of numerous golf courses with a small amount of data.

In addition, the present invention is provided such that actual putting greens and actual surrounding terrains in various golf courses, or arbitrarily generated putting greens and terrain are implemented with a small data volume, and a user is allowed to directly specify a shot location and a target point that the user wants to practice, so as to effectively practice, and suggest an effective practice approach for reading the slope of the putting green and guiding the intensity of putting.

The virtual golf course generation system of the present embodiment includes: a field template generation unit for generating a field template including information on a terrain and an altitude of a specific location and information on an object by using a results classified or extracted from different map data to generate a virtual golf course; a 3D green terrain generation unit for generating a 3D green terrain by using a three-dimensional mesh generated using terrains and altitudes of a green and a green bunker of the actual golf course to be displayed on the virtual golf course; and a matching unit for matching the generated 3D green terrain with the field template to generate the virtual golf course.

According to the virtual golf course generation system applied with a putting environment of an actual golf course based on the proposed present invention, putting greens of numerous golf courses can be used in the simulator with a small amount of data, and the system can be used in a small terminal due to the small data size.

In addition, according to the practice providing method of the present invention, locations of the ball and hole cup for putting are designated, so that the effective practice can be facilitated, and the slope for putting can be read, the strength of the putting can be determined, and guide information thereon can be guided, so that the effective practice can be facilitated.

### BRIEF DESCRIPTION OF THE DRAWINGS

FIG. 1 is a diagram showing the configuration of a virtual golf course generation system of the present invention to which an actual putting environment is applied.

FIG. 2 is a diagram for explaining a process of generating a field template by a field template generation unit according to the embodiments of the present invention.

FIG. 3 is a view showing terrain data on a green and a green bunker adjacent to the green according to the embodiments of the present invention.

FIG. 4 is a view showing a process of generating a 3D green terrain using green data according to the embodiments of the present invention.

FIGS. 5 and 6 is a view showing a state in which the green and the field are matched by the system of the present embodiment.

FIGS. 7 to 9 are views for explaining a process and a method of performing a putting practice using a virtual golf course according to the embodiments of the present invention.

FIG. 10 is a flowchart for explaining a method of providing hints during the putting on the green using the system according to the embodiments of the present invention.

### DETAILED DESCRIPTION OF THE INVENTION

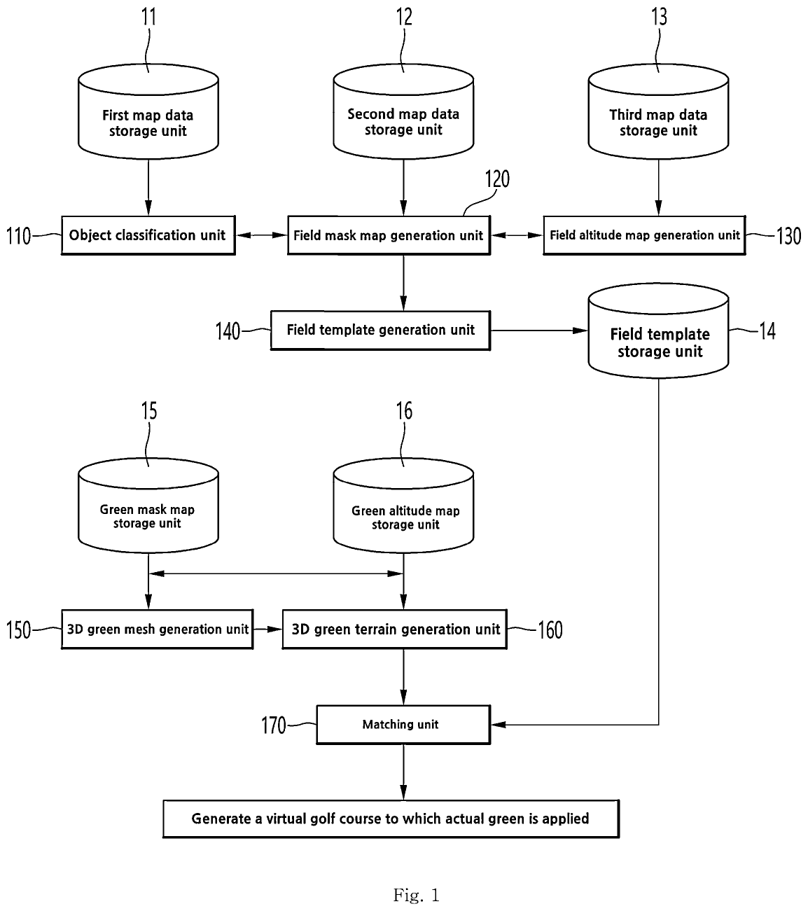

FIG. 1 is a diagram showing the configuration of a virtual golf course generation system to which an actual putting environment is applied according to the present invention. Disclosed are a configuration and a method for generating a virtual golf course according to the present invention.

In the virtual golf course generation system, map data including information distinguished from each other may be stored in a storage unit, and the information obtained from of the map data may be used, so that a golf course applied with an actual green may be generated in a short time with a small data size.

According to the present invention, the virtual golf course is generated while being divided into a green and a green bunker corresponding to terrains for putting on the golf course, and a field corresponding to the entire terrain of the golf course other than the green and the green bunker. The green bunker, which is a bunker adjacent to the green, refers to a region deeper than surroundings or formed by exposing the soil of the surface, or refers to a place formed of sand. In addition, the generated “green data” and “field data” form a virtual golf course that is a golf course to which a green arbitrarily generated by the matching unit or a green of an actual golf course is applied.

According to the embodiment, the green data refers to data required to generate a green (putting green) and a green bunker in the golf course, and the field data refers to data excluding the green data from the entire golf course data.

First, in order to generate the field data, the configurations of an object classification unit 110, a field mask map generation unit 120, a field altitude map generation unit 130, and a field template generation unit 140 will be described. Thereafter, the configuration for generating the green data will be described, and then a process of matching these data will also be described.

Generate Field Data

In the present embodiment, the field data refers to the terrain other than the green and green bunker on which the putting is performed in the virtual golf course to be generated, and may be called field data or field templates.

Referring to FIG. 1, the configuration includes storage units 11, 12 and 13 for storing first to third map data, respectively; an object classification unit 110 for classifying objects from the first map data; a field mask map generation unit 120 for generating a field mask map by extracting a terrain of a specific location among surrounding terrains including the golf course from the second map data; a field altitude map generation unit 130 for generating an altitude map by extracting an altitude for the terrain of the specific location from the third map data; a field template generation unit 140 for generating a template for a terrain of a desired specific location by using result data generated by the object classification unit 110, the field mask map generation unit 120, and the field altitude map generation unit 130; and a field template storage unit 14 in which the generated field template is stored.

The first to third map data includes different information, in which the first map data refers to map data including objects used to generate a virtual golf course, and the second map data refers to data including information on fairways and outlines of greens in the virtual golf course. In addition, the third map data refers to data including altitude information on the height of the terrain.

Specifically, the first map data may be any one of satellite, aerial and virtual maps, in which the satellite or aerial photograph may contain objects such as buildings, trees, ponds, and the virtual map may not a real photo and refer to a map generated by drawing terrains and objects.

The first map data of the present embodiment refers to data including objects required to be displayed on the virtual golf course, and may include a structure or tree erected from the ground/green, or may include natural objects such as wells or ponds formed when the ground/green is recessed.

The object data included in the first map data may represent structures or natural objects in the actual golf course, such as buildings, trees, ponds, and parking lots. The first map data is a map containing longitude and latitude coordinates, and the identified object is formed of data including longitude and latitude coordinates and a header. The header refers to information indicating a type of the object, may correspond to information that can distinguish the type of the object, in which, for example, a structure such as a building corresponds to number 1, an object erected like a tree corresponds to number 2, and an object formed when the terrain/ground is recessed corresponds to number 3.

Accordingly, the first map data may include information on a location of the object and a type of the object, and an object having the same shape may be generated and inserted at the same location by using the above information when a three-dimensional virtual golf course is generated.

Meanwhile, the second map data refers to data for displaying outlines of fairways, greens, and the like of the golf course or extracting outlines when the virtual golf course is generated. For example, the second map data may be an actual or virtual 2D data, and refers to data including outlines of a tee box, a fairway, a bunker, and a green in the golf course so as to extract shapes thereof.

The field mask map generation unit 120 serves to extract a desired terrain from the second data, for example, a shape of the green corresponding to the green data (overall outline), and a field which is the terrain adjacent to the green. For example, the shape of the putting green and the shapes of the tee box, fairway, water hazard, and bunker corresponding to the field are extracted and generated as a field mask map.

The second map data also includes longitude and latitude coordinates as in the first map data. The field mask map generation unit 120 extracts the outline of the desired terrain from the second map data including longitude and latitude coordinates, and stores the longitude and latitude coordinates of a point component of the extracted outline together with the header, so that the field mask map is generated. The header included in the generated mask map indicates information on a type of a terrain, that is, information distinguishing that, for example, the green corresponds to number 1, the bunker corresponds to number 2, and the fairway corresponds to number 3.

The header information is stored together in the field mask map generated in the above manner, so that each distinguished terrain may be generated with a desired texture at a desired location in the 3D graphics.

The third map data refers to data including information about the high and low of the terrain for each location, that is, altitude information, when the virtual golf course is generated For example, data including altitude obtained from platforms such as V-WORLD operated by the National Geographic Information Service may be used. The third map data may refer to data including altitude information not included in the first map data and the second map data.

The field altitude map generation unit 130 uses the third map data to generate a field altitude map including altitude information for the field terrain to be expressed as field data, and the corresponding altitude information is stored together with the longitude and latitude information.

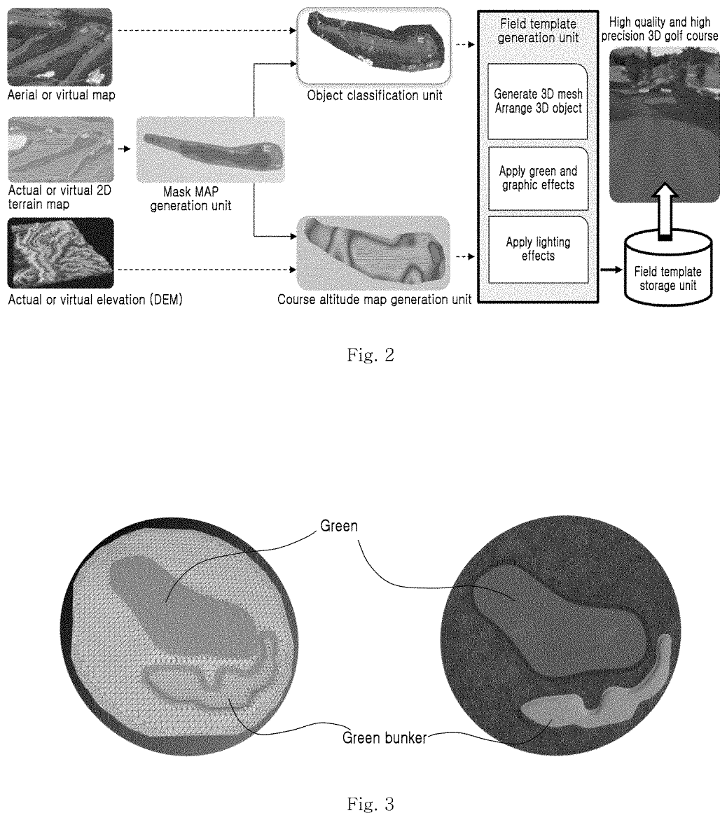

Next, the process of generating the field template by the field template generation unit 140 will be described. FIG. 2 is a diagram for explaining a process of generating a field template by a field template generation unit of the present embodiment.

The object classification unit 110 extracts/separates objects in the golf course from the first map data. For example, the object classification unit 110 separates objects such as trees, buildings, ponds, and roads from aerial or virtual golf course photos.

In addition, the field mask map generation unit 120 generates a field mask map for expressing a size and a location of the field terrain, by using the outline information of the terrain corresponding to the field that is the terrain adjacent to the green. For example, the field mask map generation unit 120 generates a mask map including information on locations and sizes of the terrains constituting the virtual golf course to be generated, by extracting locations of the fairway, hazard, water hazard, cart road, and green in the golf course from the actual or virtual 2D terrain map.

In addition, the field altitude map generation unit 130 generates a field altitude map including height information, that is, altitude information, of each terrain constituting the field mask map. For example, the field altitude map generation unit 130 extracts an altitude map of a required portion from the actual or virtual field altitude map and store the extracted altitude map as a field altitude map.

Next, the field template generation unit 140 generates a 3D mesh by using the classified object, field mask map, and field altitude map, and generates a 3D basic graphic environment by inserting the classified object. In addition, the field template generation unit 140 generates a final field template by adding effects for enhancing the texture of objects and grass and lighting effects. The above field template as field data is matched with the green data (3D green terrain) generated later, so as to be used to generate a virtual golf course which the user may practice.

The field template as field data generated by the field template generation unit 140 is stored in the field template storage unit 14 that is a storage space in the terminal. In addition, each object information, such as type, location, size information, classified by the object classification unit 110 is stored together in the field template storage unit 14, and the above stored object information is later used together with the field template and 3D green terrain data to generate a final virtual golf course.

Next, the process of generating the green data for allowing the user to perform the putting will be described.

Generate Green Data

Referring back to FIG. 1, the process of generating green data significantly close to the actual golf course will be described in order to practice putting using a putter as if practicing on the green of the actual golf course.

As described above, the green data includes terrain data on the green (putting green) in which putting is performed in the golf course, and terrain data on the green bunker adjacent to the green.

The terrain data for the green bunker, which is the bunker adjacent to the green, as illustrated in FIG. 3, relates to a bunker formed within 30 m to 50 m about a center of the green (reference point). The reference of the adjacent distance may be set beyond the range of 30 m to 50 m according to the size of the green.

The virtual golf course generation system to which the actual putting environment is applied according to the present embodiment also includes a configuration for generating green data so as to be used to generate terrains of greens and green bunkers, in addition to the aforementioned configuration for generating the field data.

The system of the present embodiment includes: a green mask map storage unit 15 in which a mask map capable of distinguishing the terrain features of the green and the green bunker is stored; a green altitude map storage unit 16 in which three-dimensional altitude information on the green and the green bunker is stored; a 3D green mesh generation unit 150 for generating the terrains of the green and green bunker as a 3D mesh using the green mask map and the altitude map; and a 3D green terrain generation unit 160 for generating shadows drawn by the green altitude map and generating a 3D green terrain by using information on the generated 3D mesh and the generated shadows, and includes: a matching unit 170 for matching the generated 3D green terrain with the field template to generate a virtual golf course to which an actual green is applied.

In addition, the system may further include a shadow generation unit for forming the green and the green bunker in a 3D space from the green mask map and then generating a shadow by irradiating light in order to more clearly distinguish the terrains of the green and the green bunker using the green altitude map. When a difference in altitude between the green and the green bunker is small, the shadow generation unit may form the shadow through light irradiation in the 3D space so as to additionally distinguish the green and the green bunker.

In the embodiment, the green data including the green and the green bunker, and the field data in which terrain features and objects constitute the golf course other than the green data are distinguished, stored and generated, so that each data is configured to have a small volume and each data is also processed quickly.

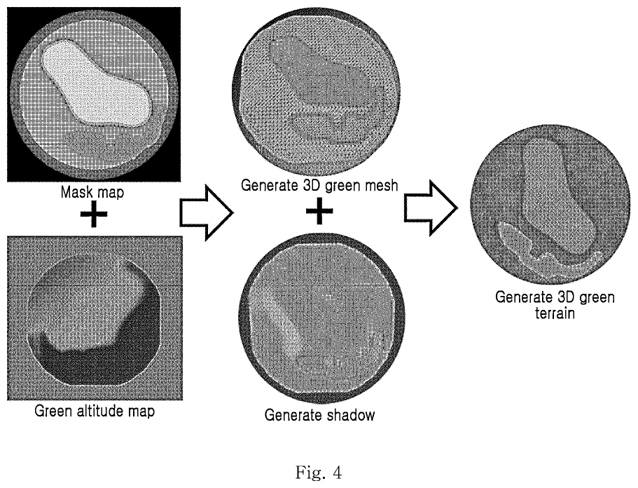

FIG. 4 is a view showing a process of generating a 3D green terrain using green data according to the embodiment.

Referring to FIG. 4 together, the shape of the actual golf course is used for the shape of the green as it is in the embodiment, and a mask map, not a photo, is generated and store in advance to reduce the amount of data. The green mask map stored in the green mask map storage unit 15 includes a shape/contour of the green bunker in addition to the shape of the green.

Since the green is very small compared to the entire size of the golf course, only the altitude maps of the green and the green bunker are separately extracted and stored in the green mask map storage unit 15 in order to reduce the size of the data.

The mask map and the altitude map generated through the above process may be within several tens of K bytes after compression, a large amount of green information may be stored in a terminal having a small memory size, and the data may also be transmitted at high speed through a network environment.

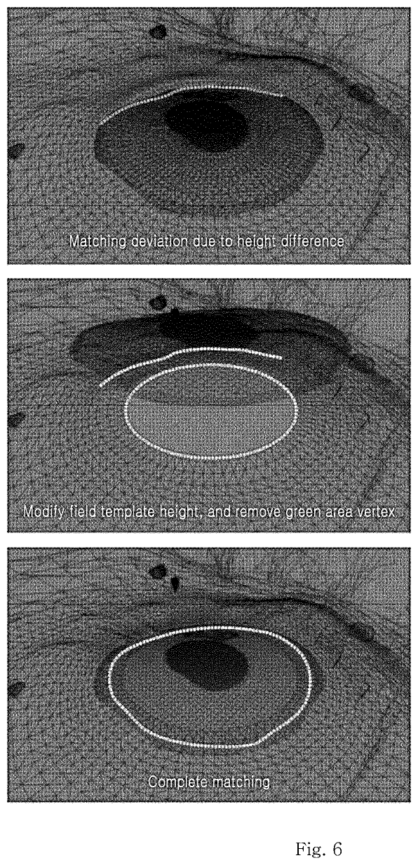

The terrain of the green in the 3D space is generated by the 3D green mesh generation unit 150 in the terminal. First, the shapes of greens and green bunkers are generated in the 3D space by using the mask maps of greens and green bunkers. At this point, since the generated shape is a flat two-dimensional plane that does not reflect the height, the altitude map is used to express the height. The above expression has the same form as the 3D green mesh in FIG. 6. The 3D green terrain generation unit 160 in the terminal functions to generate a final 3D green terrain, by applying sand textures of grass or bunker to the mesh and forming shadows for visual expression of the height.

In addition, when the performance of CPU or graphics of the terminal is low, the 3D green mesh may be generated and stored in advance and then transmitted. This data may be generated within several hundred k bytes on the basis of compression for one hole.

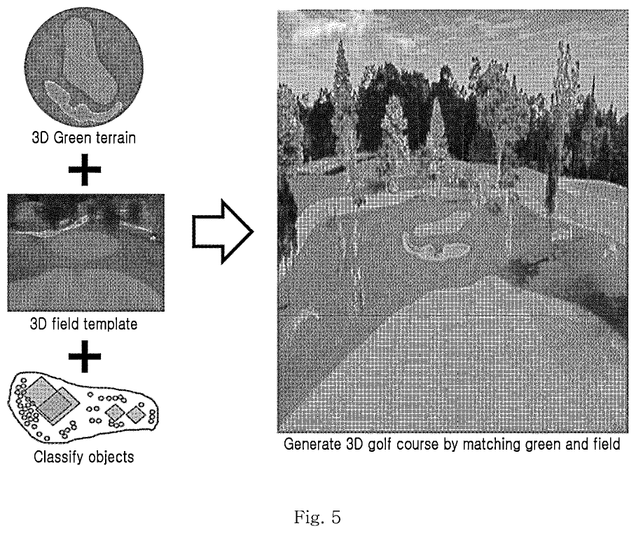

FIGS. 5 and 6 is a view showing a state in which the green and the field are matched by the system of the present embodiment.

The matching unit 170 uses the 3D green terrain generated using the 3D green mesh together with the field template and object information stored in the field template storage unit 14. In other words, as shown in FIGS. 5 and 6, the generated field template may or may not contain greens, but contains the coordinates of the location where the green is matched.

Accordingly, when terrain features of the green and green bunker are matched to the green location identified through the field template the height of the already generated field template may be different from the height of the green and green bunkers, and accordingly, the terrain in the field template may rise or fall compared to the greens and green bunkers. Thus, the matching process of matching the above height difference may be conducted. Since the deformation in height of the green on the actual golf course is not allowed, the height of the field template is matched to the height of the green and green bunker. In the case that one part of the green is too high, only the height of a part of the field to be matched to the high part is raised and matched, so that the matched part is shaped like a hill. At this point, objects behind the field viewed from the green may be invisible or partially visible. Accordingly, all heights in the field template are varied according to the height of the green, so that the matching process is completed.

More specifically, a vertex of the field template to be matched to the green is found and recorded as a reference height Yref[x][y], and matched based on the height of an edge of the green, and accordingly, the vertex of the field template existing inside the green is deleted after being matched.

In addition, a ray-cast is applied to the edge of the green upward and downward to calculate Ydif[x][y], which is a spaced size with respect to all vertices of the green edge and fields; all vertices in the field corresponding to the vertices of the green edge are found to adjusts the height of the field vertex according to the value of Ydif[x][y] of the green edge; and Ydif[x][y] is adjusted by gradation for natural adjustment.

In addition, when the field is above the green after ray-casted to the lower part of the vertices of the field, a primarily re-inspection process for lowering the height of the vertex of the field is carried out. In contrast, when the green is under the field after ray-casted to the upper part of the vertices of the green, a secondarily re-inspection process is performed for increasing the vertex height of the green.

While changing the entire height of vertex of the field template based on Yref[x][y] and Ydif[x][y], the physics and mesh are synchronized.

Next, the method will be described that a putting is practiced just like being practiced on the actual green by using the virtual golf course generated as described above.

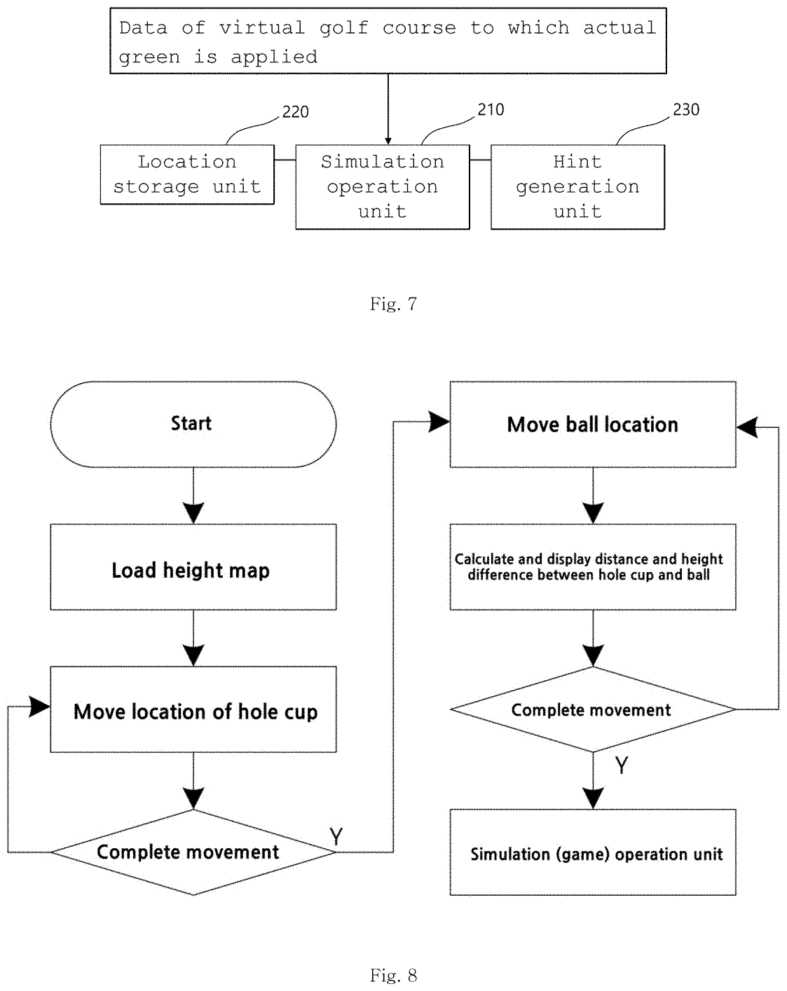

FIGS. 7 to 9 are views for explaining a process and a method of performing a putting practice using a virtual golf course according to the embodiment.

First, FIG. 7 shows a configuration for allowing a user to practice on a virtual golf course to which an actual green is applied, that is, a golf course on an actual green, and the configuration includes: a simulation operation unit 210 for providing the user with putting practices and hints by using the virtual golf course data; a location designation unit 220 for enabling the user to specify a location of a hole cup and a ball on the green as the user desired; and a hint generation unit 230 for providing hints about height and inclination upon putting at a designated location.

The simulation operation unit 210, the location designation unit 220, and the hint generation unit 230 correspond to the configuration included in the system described in FIG. 1, As described above, all of the configuration for generating the field data and the green data, and the configuration for practicing by using the generated virtual golf course data are included in the system of the present invention.

The graphic data of the final generated 3D golf site (golf course) is connected with a dense mesh of quality that allows the user to specify the locations of the hole cup and the ball as desired.

The simulation operation unit 210 may display the hole cup and ball together with the three-dimensional golf course, and allow the user to move the hole cup and ball to the desired locations by using the keyboard, mouse, and remote control. Any location of the hole cup and the ball may be designated first. The object designated as a second location is displayed after the simulation operation unit 210 calculates a distance difference and a height difference from the first designated object.

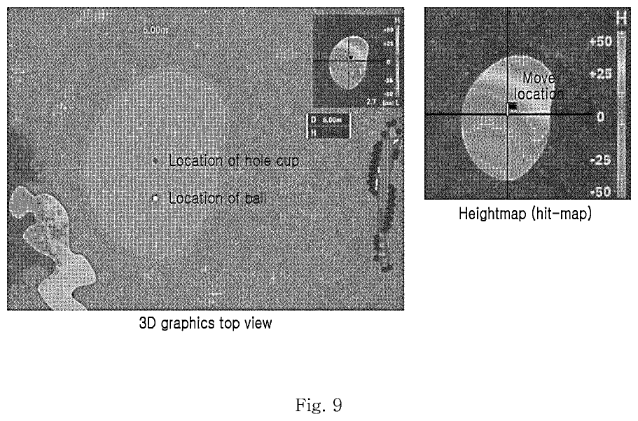

For example, when the location of the hole cup is designated first, and the location of the ball is designated second, the simulation operation unit 210 displays the height difference and distance difference between the hole cup and the ball in real time whenever the user changes the location of the ball, thereby guiding the user to choose the appropriate location. A set of the above-described processes is also performed on the hit-map (FIG. 9) that expresses the height difference, in which the hit-map contains a distance resolution in pixel units, and the hit-map itself expresses the height, so that the difference between height and distance can be quickly calculated in real time.

Since the hit-map is obtained by reducing the 3D golf course by the predetermined ratio, the designated location may be easily converted into the location of the three-dimensional golf course, so that the putting may be performed right after the location is designated.

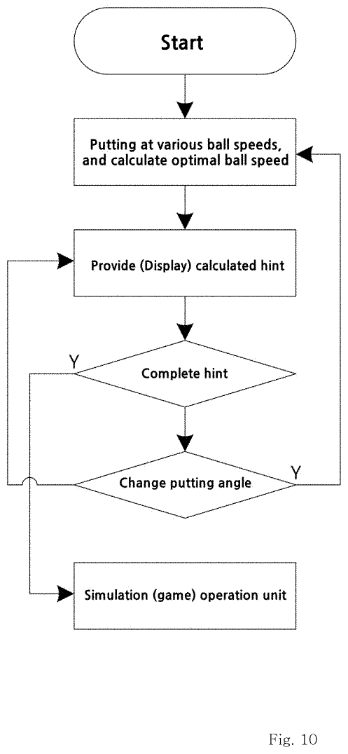

Meanwhile, the hint generation unit 230 serves to receive information about the height, slope, and distance of the putting green from the simulation operation unit 210, and provide hints according to the location of the ball for efficient practice to the user. FIG. 10 is a flowchart for explaining a method of providing hints during the putting on the green by using the system according to an embodiment of the present invention.

When the putting starts first, the putting direction is in a straight line between the ball and the hole cup. However, since the putting green includes the height and slope, the putting in a straight line does not signify a success of putting. The hint generation unit 230 of the system conducts a virtual simulation with various ball speeds from the current angle, thereby finding and outputting the ball speed that may be closest to the hole cup.

The starting angle of putting may be rotated to the left or right by the desired angle according to the user's request, so that the rotated angle is displayed upon every rotation, and the optimal ball speed is indicated in the same way as above. In addition, the remaining distance from the hole cup is calculated and displayed in advance for the putting performed at the optimal ball speed, thereby enable the user to specify the starting angle of the putting.

What is claimed is:

1. A virtual golf course generation system to which terrain information of a green of an actual golf course is applied, the virtual golf course generation system comprising:
a field template generation unit for generating a field template including information on a terrain and an altitude of a specific location and information on an object, by using a result classified or extracted from different map data so as to generate a virtual golf course;
a 3D green terrain generation unit for generating a 3D green terrain by using a three-dimensional mesh generated using terrains and altitudes of a green and a green bunker of the actual golf course to be displayed on the virtual golf course; and
a matching unit for matching the generated 3D green terrain with the field template to generate the virtual golf course.

2. The virtual golf course generation system of claim 1, wherein the map data includes first map data and second map data including longitude and latitude coordinates, and third map data including an altitude for a terrain of a specific location, and wherein
virtual golf course generation system further comprises:
an object classification unit to classify the object from the first map data; and
a field mask map generation unit for generating a field mask map by extracting a terrain of a specific location among surrounding terrains including the actual golf course from the second map data.

3. The virtual golf course generation system of claim 2, further comprising:
a field altitude map generation unit for generating an altitude map by extracting an altitude for the terrain of the specific location from the third map data; and
a 3D green mesh generation unit for generating the terrains of the green and the green bunker as a 3D mesh by using a green mask map for distinguishing terrain features of the green and the green bunker, and three-dimensional altitude information on the green and the green bunker, wherein
the matching unit confirms a location of the green through the field template, and simultaneously performs a process of matching a height difference between the terrain of the field template and the green and green bunker when matching the terrain features of the green and green bunker to the location of the green.

4. A virtual golf course generation system, wherein the virtual golf course generation system matches a field template including information on a terrain and an altitude of a green and information on an object with 3D green terrains for the green and a green bunker to allow a user to practice, wherein the user is allowed to specify both locations of a hole cup and a ball, or specify a location of any one of the hole cup and the ball on a green of an actual golf course or a green of a virtual golf course to which an arbitrarily generated green is applied, by using a keyboard, a mouse or a remote control, so that the practice is performed.

5. The golf course generation system of claim 4, wherein a virtual simulation is performed at various ball speeds by the system with respect to a current angle of the ball located by the user, and an actual putting environment including a process of displaying a ball speed directed and closest to the hole cup to the user is applied.
